(19) United States
(12) Patent Application Publication
(10) Pub. No.: US 2003/0210714 A1
(43) Pub. Date: Nov. 13, 2003

(54) METHOD FOR AVOIDING LOSS OF PDCP PDUS IN A WIRELESS COMMUNICATIONS SYSTEM

(76) Inventor: Chih-Hsiang Wu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,965

(22) Filed: Mar. 6, 2003

Related U.S. Application Data
(60) Provisional application No. 60/319,239, filed on May 10, 2002.

(51) Int. Cl. H04J 3/06

(52) U.S. Cl. 370/503

(57) ABSTRACT

PDCP peer entities should perform a PDCP sequence number synchronization procedure following any RRC procedure that can lead to loss of PDCP PDUs. These procedures include Transport Channel Reconfiguration, Radio Bearer Setup, Radio Bearer Release, and Cell Update procedures, and are characterized in that each of the RRC procedures is capable of initiating an SRNS relocation procedure. Further, each of the procedures is capable of causing the RLC peer entities associated with the PDCP peer entities to be re-established. A PDCP re-synchronization module is provided in a wireless device to detect execution of such an RRC procedure, and in response initiates a PDCP sequence number synchronization procedure.

### CROSS REFERENCE TO RELATED APPLICATIONS

The application claims the benefit of U.S. Provisional Application No. 60/319,239, filed May 10, 2002, and included herein by reference.

### BACKGROUND OF INVENTION

1. Field of the Invention

The present invention relates to a wireless communications network. In particular, the present invention discloses a method for avoiding the loss of packet data convergence protocol (PDCP) protocol data units (PDUs) during certain radio resource control (RRC) procedures.

2. Description of the Prior Art

Please refer to FIG. 1. FIG. 1 is a block diagram of a wireless communications network 10, as defined by the 3 Generation Partnership Project (3GPP) specifications 3GPPTS 25.322 V3.10.0 “RLC Protocol Specification”, and 3GPPTS 25.331 V3.10.0 “Radio Resource Control (RRC) Specification”, which are included herein by reference. The wireless communications network 10 comprises a plurality of radio network subsystems (RNSs) 20 in communications with a core network (CN) 30.

The plurality of RNSs 20 is termed a Universal Mobile Telecommunications System (UMTS) Terrestrial Radio Access Network, or UTRAN for short. Each RNS 20 comprises one radio network controller (RNC) 22 that is in communications with a plurality of Node Bs 24. Each Node B 24 is a transceiver, which is adapted to send and receive wireless signals. In particular, the wireless communications network 10 assigns a mobile unit 40 (generally termed a “UE” for User Equipment) to a particular RNS 20, which is then termed the serving RNS (SRNS) 20s of the UE 40. Data destined for the UE 40 is sent by the CN 30 to the SRNS 20s. This data is in the form of service data units (SDUs) 28 that are held by the RNC 22 of the SRNS 20s pending transmittal by one of the Node Bs 24. The RNC 22 selects a Node B 24 that is best able to accurately transmit the SDUs 28 to the UE 40. Such a selection will depend, for example, upon the location of the UE 40 within the domain of the SRNS 20s. The UE 40 broadcasts SDUs 48 to the wireless communications network 10, which are then picked up by the SRNS 20s and forwarded to the CN 30. Occasionally, the UE 40 may move close to the domain of another RNS 20, which is termed a drift RNS (DRNS) 20d. A Node B 24 of the DRNS 20d may pick up the signal transmitted by the UE 40. The RNC 22 of the DRNS 20d forwards the received signal to the SRNS 20s. The SRNS 20s uses this forwarded signal from the DRNS 20d, plus the corresponding signals from its own Node Bs 24 to generate a combined signal that is then decoded and finally processed into SDUs 48. The SRNS 20s then forwards these received SDUs 48 to the CN 30. Consequently, all communications between the UE 40 and the CN 30 must pass through the SRNS 20s.

Please refer to FIG. 2 in conjunction with FIG. 1. FIG. 2 is a simple block diagram of the UMTS radio interface protocol architecture. Communications between the UE 40 and the UTRAN 20u is effected through a multi-layered communications protocol that includes a layer 1, a layer 2 and a layer 3, which together provide transport for a signaling plane (C-plane) 92 and a user plane (U-plane) 94. Layer 1 is the physical layer 60, and in the UTRAN 20u is responsible for combining signals received from the DRNS 20d and SRNS 20s. Layer 2 includes a packet data convergence protocol (PDCP) layer 70, a Radio Link Control (RLC) layer 72, and a Medium Access Control (MAC) layer 74. Layer 3 includes a Radio Resource Control (RRC) layer 80. The U-plane 94 handles user data transport between the UE 40 and the UTRAN 20u, whereas the C-plane 92 handles transport for signaling data between the UE 40 and the UTRAN 20u. The RRC 80 sets up and configures all channels between the UTRAN 20u and the UE 40. The PDCP layer 22 provides header compression for Service Data Units (SDUs) received from the U-plane 94. The RLC layer 72 provides segmentation and concatenation of PDCP 70 SDUs and RRC 80 SDUs into RLC protocol data units (PDUs), and under acknowledged mode (AM) transfers, can provide upper layers (such as the PDCP layer 70 or the RRC layer 80) with a confirmation that RLC PDUs have been successfully transmitted and received between the UTRAN 20u and the UE 40. The MAC layer 74 provides scheduling and multiplexing of RLC PDUs onto the transport channel, interfacing with the physical layer 60.

Before proceeding, it is worth taking note of terminology used in the following. An SDU is any packet that is received from an upper layer or passed to an upper layer, whereas a PDU is a packet generated by a layer and passed on to a lower layer or received from a lower layer. Hence, a PDCP PDU is an RLC SDU. Similarly, an RLC PDU is a MAC SDU, and so forth. Each PDCP PDU generated by the PDCP layer 70 in response to an SDU received from the U-plane 94 is incrementally assigned a 16-bit sequence number (SN) by the PDCP layer 70, if a so-called lossless property is configured for the connection. The idea of a lossless connection is elaborated upon later. That is, each sequentially successive PDCP PDU generated by the PDCP layer 70 is assigned an incrementally higher SN. For example, at a given instant in a stream of PDCP PDUs, a first PDCP PDU may be assigned an SN of 62. A second PDCP PDU generated immediately after the first PDCP PDU would thus be assigned an SN of 63, and so on. When the PDCP entity is first set-up, the first PDCP PDU of the entity has a SN of zero. The SNs are not actually a part of the PDCP PDUs, but are internally maintained by the PDCP layer 70. The PDCP PDUs are then delivered to the RLC layer 72 for transmission. Since bandwidth is to be maximized by the compression of the U-plane SDU headers, each PDCP PDU should, ideally, be smaller in size than its corresponding U-plane SDU. To ensure that this is indeed the case, the PDCP headers should be kept as small as possible, and to provide for this, PDCP SNs are generally not transmitted in their associated PDCP PDUs. Similarly, each PDCP PDU received from the RLC layer 72 is incrementally assigned an SN by the PDCP layer 70. Hence, two unique sets of PDCP SNs exist: one for PDCP PDUs received from the RLC layer 72, and another for PDCP PDUs generated from U-plane 94 SDUs.

As the UE 40 moves closer towards the domain of the DRNS 20d, a decision is eventually made by the wireless network 10 to place the UE 40 under the DRNS 20d, and a transfer process is enacted. This process is termed an SRNS relocation procedure, and under certain transport modes is a lossless procedure. Lossless means that no PDCP SDUs 28, 48 are lost during the relocation procedure. Please refer to FIG. 3 in conjunction with FIGS. 1 and 2. FIG. 3 is a block diagram of the UE 40 undergoing a lossless SRNS relocation procedure. The DRNS 20d becomes a target RNS (TRNS) 20t. After completion of the relocation procedure, the TRNS 20t will serve as the new SRNS 20s for the UE 40. In order for the TRNS 20t to properly take up its job as the new SRNS 20s for the UE 40, the current SRNS 20s must forward key information to the TRNS 20t. Please refer to FIG. 4 in conjunction with FIGS. 2 and 3. FIG. 4 is a message sequence chart for the prior art lossless SRNS relocation procedure. The SRNS 20s sends forwarding information 50 to the TRNS 20t. This forwarding information includes a downlink sending sequence number (DL Send_SN) 52, an uplink receiving sequence number (UL Receive_SN) 54, and all unconfirmed PDCP SDUs 28. The multi-layered communications protocol used by both the SRNS 20s and the UE 40 enables the UE 40 to confirm those PDCP PDUs transmitted by the SRNS 20s that are successfully received by the UE 40. Any PDCP PDUs not explicitly confirmed as received by the UE 40 are termed unconfirmed PDCP PDUs. As each PDCP SDU 28 has a corresponding PDCP PDU, an unconfirmed PDCP PDU generally means that there is a corresponding unconfirmed PDCP SDU 28. These unconfirmed PDCP SDUs 28 are forwarded by the SRNS 20s to the TRNS 20t. The DL Send_SN 52 is the value of the SN associated with the sequentially earliest unconfirmed PDCP SDU. As the SNs are not explicitly carried in the PDCP PDUs, this enables the PDCP layer 70 in the TRNS 20t to properly associate an SN for the corresponding PDCP PDU of each forwarded PDCP SDU 28. The UL Receive_SN 54 is the value of the SN associated with a PDCP SDU that the SRNS 20s next expects to receive from the UE 40. This enables the TRNS 20t to properly associate an SN for each PDCP SDU subsequently received from the UE 40. The TRNS 20t sends the UL Receive_SN 54 to the UE 40. From this, the UE 40 can determine which PDCP SDUs to begin sending to the TRNS 20s under its guise as the new SRNS 20s. The UE 40 sends a downlink receiving sequence number (DL Receive_SN) 58 to the TRNS 20s. The DL Receive_SN 58 holds the value of the SN of the next PDCP SDU that the UE 40 is expecting to receive from the TRNS 20t. From this, the TRNS 20t can learn which of the forwarded unconfirmed PDCP SDUs 28 to begin sending to the UE 40. Consider, as an example, a situation in which the SRNS 20s has sent PDCP PDUs, each of which has a corresponding PDCP SDU to the UE 40 having associated SNs running from 0 to 99. We may further assume that, of these 100 PDCP PDUs sent, only those with SNs running from 0 to 50 were confirmed by the UE 40. Consequently, there are unconfirmed PDCP PDUs with SNs running from 51 to 99, each of which has a corresponding unconfirmed PDCP SDU 28. Also, the SRNS 20s has received 200 PDCP PDUs, each of which has a corresponding PDCP SDU, from the UE 40, with SNs running from 0 to 199. In the SRNS relocation procedure, the PDCP SDUs 28 with associated SNs running from 51 to 99 are forwarded by the SRNS 20s to the TRNS 20t. The DL Send_SN 52 would have a value of 51, and the UL Receive_SN 54 would have a value of 200. The DL Receive_SN 58 will hold a value that is between 51 and 100, depending on how many of the unconfirmed PDCP PDUs were actually received by the UE 40, but not yet confirmed. If, for example, the DL Receive_SN 58 holds a value of 90, then the TRNS 20t knows that it may discard the forwarded PDCP SDUs 28 that have associated SNs that run from 51 to 89, and will begin transmitting those forwarded PDCP SDUs 28 with associated SNs that are from 90 and above. Although it should not happen, it is possible that the DL Receive_SN 58 will either be sequentially before the DL Send_SN 52 or sequentially after the SN associated with the sequentially last forwarded PDCP SDU 28. Such an occurrence means that the SNs maintained by the RNC 22 of the SRNS 20s are out of synchronization with corresponding SNs maintained by the UE 40. A PDCP sequence number synchronization procedure is thus enacted by the TRNS 20t, or by the UE 40, depending upon which device detects the lack of synchronization of the PDCP sequence numbers. During the PDCP sequence number synchronization procedure (and assuming for the sake of example that it is the TRNS 20t that has detected un-synchronization of the PDCP sequence numbers), the TRNS 20t transmits a PDCP PDU that explicitly contains its associated SN in its PDCP header, with the data region of this PDCP PDU corresponding to the sequentially earliest forwarded PDCP SDU 28. This PDU is termed a PDCP SeqNum PDU. Once the UE 40 has confirmed this PDCP SeqNum PDU (by way of the RLC layer 72), the TRNS 20t considers the PDCP sequence number synchronization procedure completed.

The primary purpose of having PDCP PDU SNs is to support lossless SRNS relocation, as discussed above. Un-synchronization of PDCP SNs between two PDCP entities (i.e., the UE 40 and the UTRAN 20u) can lead to PDCP PDU loss. The PDCP sequence numbersynchronization procedure as discussed above avoids such loss. In all cases in the prior art, it is the RRC layer 80, in either the UTRAN 20u or the UE 40, that instructs the PDCP layer 70 to perform the PDCP sequence number synchronization procedure. The prior art notes three cases in which a PDCP sequence number synchronization procedure should occur:

1) During an RLC Reset procedure.

2) During a Radio Bearer Reconfiguration procedure.

3) During a lossless SRNS relocation when un-synchronization is detected between the sequence numbers of the two PDCP entities.

However, there are times that a PDCP sequence number synchronization procedure should be performed that are not covered by the prior art, and which can thus lead to loss of PDCP PDUs, thereby defeating the desired lossless communications characteristic in the U-plane 94 between the UTRAN 20u and the UE 40.

### SUMMARY OF INVENTION

It is therefore a primary objective of this invention to provide a method for ensuring lossless communication between PDCP peer entities.

Briefly summarized, the preferred embodiment of the present invention discloses a method for determining when to perform a PDCP sequence number synchronization procedure between two PDCP peer entities. The PDCP peer entities should perform a PDCP sequence number synchronization procedure following any RRC procedure that can lead to loss of PDCP PDUs. These procedures include Transport Channel Reconfiguration, Radio Bearer Setup, Radio Bearer Release, and Cell Update procedures, and are characterized in that each of them is capable of initiating an SRNS relocation procedure. Further, each of the procedures is capable of causing the RLC peer entities associated with the PDCP peer entities to be re-established.

It is an advantage of the present invention that by always performing PDCP sequence number synchronization during those RRC procedures that are capable of losing PDCP PDUs, lossless communications between the two peer entities is better assured.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a wireless communications system.

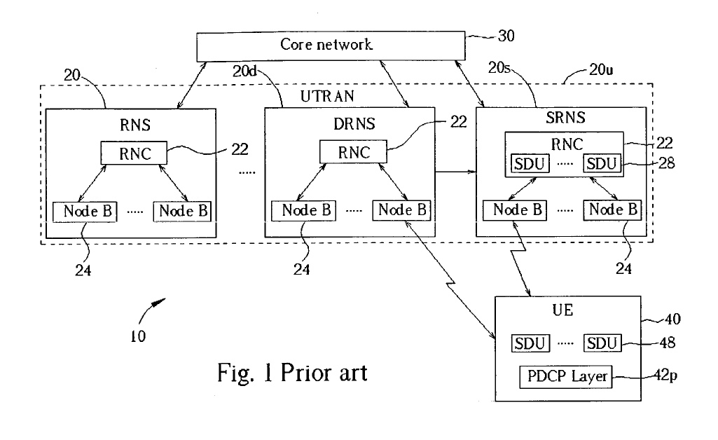

FIG. 2 is a simple block diagram of a UMTS radio interface protocol architecture.

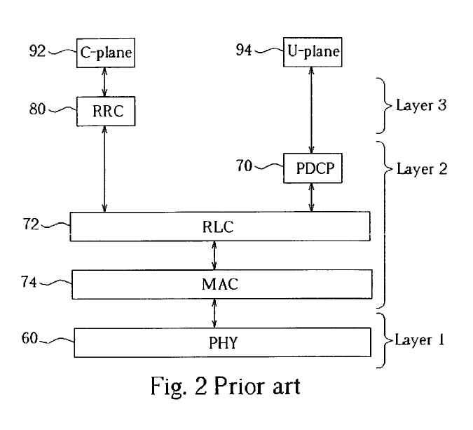

FIG. 3 is a block diagram of a mobile unit of FIG. 1 undergoing a lossless SRNS relocation procedure.

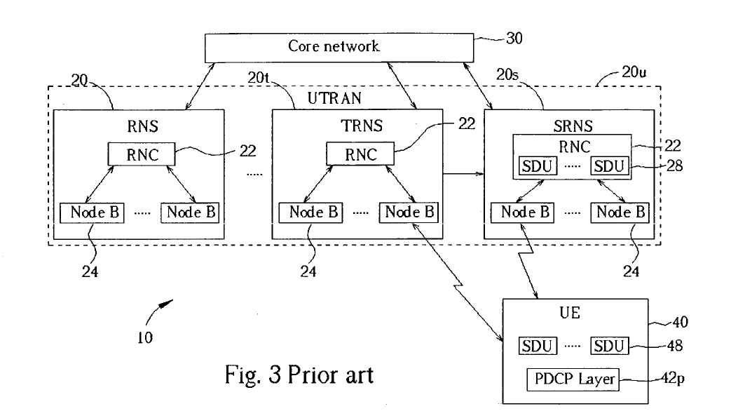

FIG. 4 is a message sequence chart for a prior art lossless SRNS relocation procedure.

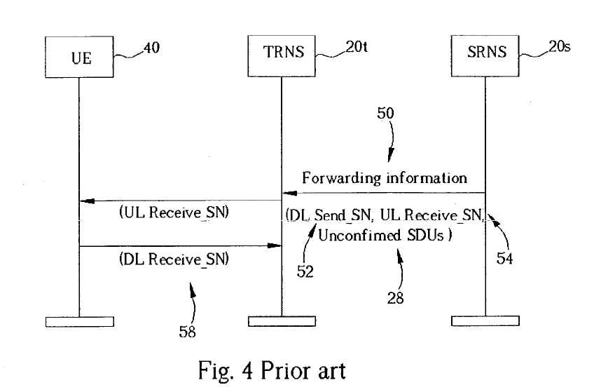

FIG. 5 is a simple block diagram of a UMTS radio interface protocol architecture according to the present invention.

FIG. 6 is a message sequence chart for performing a RRC Radio Bearer Setup procedure according to the present invention.

FIG. 7 is a message sequence chart for performing a RRC Radio Bearer Release procedure according to the present invention.

FIG. 8 is a message sequence chart for performing a RRC Transport Channel Reconfiguration procedure according to the present invention.

FIG. 9 is a message sequence chart for performing a RRC Cell Update procedure according to the present invention.

### DETAILED DESCRIPTION

In the following description, user equipment (UE) may be a mobile telephone, a handheld transceiver, a personal data assistant (PDA), a computer, or any other device that requires a wireless exchange of data. It is assumed that this wireless exchange of data conforms to 3GPP-specified protocols. It should be understood that many means may be used for the physical layer to effect wireless transmissions, and that any such means may be used for the system hereinafter disclosed.

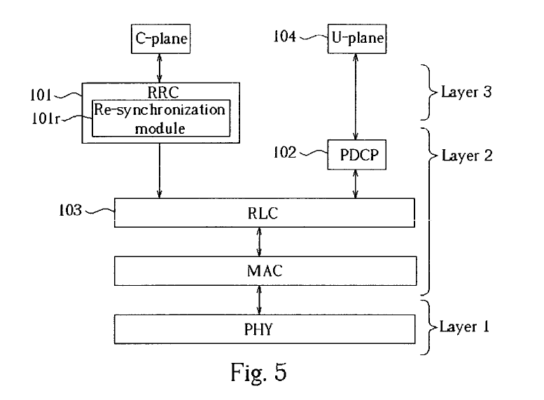

Please refer to FIG. 5. FIG. 5 is a simple block diagram of a UMTS radio interface protocol architecture according to the present invention. The basic structure of the present invention UMTS radio interface protocol architecture is much like that of the prior art. Specifically, a three-layered interface is provided, with the layer 3 interface including an RRC layer 101. However, the present invention RRC layer 101 includes a re-synchronization module 101r that causes the RRC layer 101 to instruct a PDCP layer 102 in the layer 2 interface to perform a PDCP sequence number synchronization procedure when certain specific RRC procedures are performed. Implementing the re-synchronization module 101r should be clear to one reasonably skilled in the art after reading the following detailed description of the present invention method. The RRC procedures of concern to the re-synchronization module 101r include Transport Channel Reconfiguration, Radio Bearer Setup, Radio Bearer Release, and Cell Update procedures, in addition to the prior art RRC Radio Bearer Reconfiguration procedure, and the RLC Reset procedure. All of these RRC procedures are characterized in that they can perform a SRNS relocation procedure. Further, all of these RRC procedures are capable of causing the RLC layer 103 associated with the PDCP layer 102 to be re-established, and hence lead to a potential loss of untransmitted RLC PDUs. Thus, all of the RRC procedures are ultimately characterized in that they can potentially lead to a loss of PDCP PDUs. Performing a PDCP sequence number synchronization process helps to prevent such potential PDCP PDU loss. Each of these RRC 101 procedures is capable of performing SRNS Relocation by including a “Downlink counter synchronization info” information element (IE) in the RRC 101 message. By including the “Downlink counter synchronization info” IE in the RRC 101 messages (Radio Bearer Setup, Radio Bearer Release, Transport Channel Reconfiguration, and Cell Update), the UTRAN commands the UE to change its SRNC. If the “Downlink counter synchronization info” IE is not included, SRNS Relocation is not performed (i.e., not combined with these RRC 101 procedures). After performing one of these RRC 101 procedures, the SRNS Relocation is performed—if the RRC 101 procedure includes the “Downlink counter synchronization info” IE. In either case, whether or not SRNS relocation is performed, PDCP sequence number synchronization will be performed.

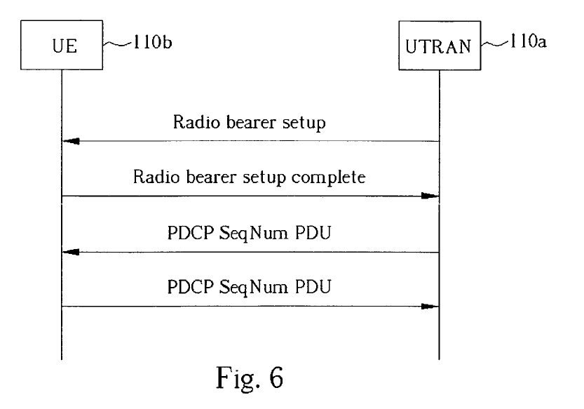

Please refer to FIG. 6 with reference to FIG. 5. FIG. 6 is a message sequence chart for performing a RRC 101 Radio Bearer Setup procedure according to the present invention. A UTRAN 110a sends a standard Radio Bearer Setup message to a UE 110b. The Radio Bearer Setup procedure establishes a new radio bearer for transmission and reception of user data, i.e., transmission along the U-plane 104. The radio bearer establishment is based on Quality of Service (QoS), and performs assignment of RLC 103 parameters, multiplexing priority for the Dedicated Traffic Channel (DTCH), Common Packet Channel (CPCH) Set assignment, the scheduling priority for the Dedicated Channel (DCH), Transport Format Set (TFS) for the DCH, and updating of the Transport Format Combination Set (TFCS). The Radio Bearer Setup procedure may also include reconfiguration of radio bearers (e.g. the assignment of a physical channel, and changing of the used transport channel types/RRC 101 state). Note that if the UTRAN 110a only reconfigures radio bearers, then the UTRAN 110a normally uses the RRC 101 Radio Bearer Reconfiguration procedure. In response to the Radio Bearer Setup procedure, the re-synchronization module 101r on the UTRAN 110a causes the RRC layer 101 to instruct the PDCP layer 102 to initiate a standard PDCP sequence number synchronization procedure with a PDCP SeqNum PDU. The re-synchronization module 101r causes the PDCP sequence number synchronization procedure to be performed on PDCP 102 peer entities belonging to radio bearers configured to support lossless SRNS Relocation, and which existed before performing the Radio Bearer Setup procedure. It is the UTRAN 110a that indicates which PDCP 102 entities should perform lossless SRNS Relocation. The re-synchronization module 101r on the UE 110b similarly causes a PDCP sequence number synchronization procedure to be performed, with each affected PDCP peer entity 102 of the UE 110b sending a PDCP SeqNum PDU of its own. The sequence numbers maintained by the relevant peer entity PDCP layers 102 between the UE 110b and the UTRAN 110a are thereby synchronized.

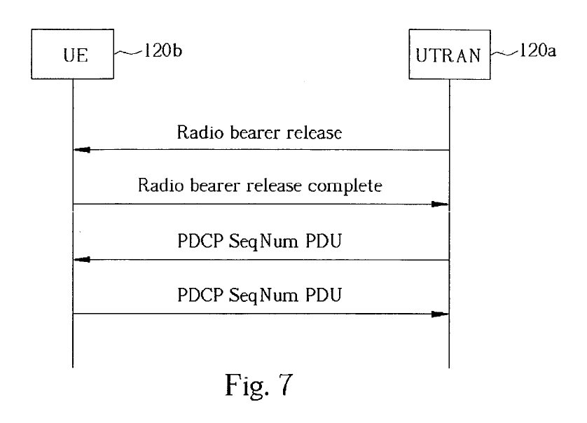

Please refer to FIG. 7 with reference to FIG. 5. FIG. 7 is a message sequence chart for performing a RRC 101 Radio Bearer Release procedure according to the present invention. A UTRAN 120a sends a standard Radio Bearer Release message to a UE 120b. This RRC 101 procedure releases a radio bearer. The RLC entity 103 for the radio bearer is released. The procedure may also release a DCH, which affects the TFCS. It may include release of a physical channel or channels. It may also include reconfiguration of radio bearers (e.g. changing the used transport channel types/RRC 101 state). In response to the Radio Bearer Release procedure, the re-synchronization module 101r on the UTRAN 120a causes the RRC layer 101 to instruct the PDCP layer 102 to initiate a standard PDCP sequence number synchronization procedure on PDCP 102 peer entities belonging to radio bearers configured to support lossless SRNS Relocation and that have not been released. The re-synchronization module 101r on the UE 120b similarly causes a PDCP sequence number synchronization procedure to be performed.

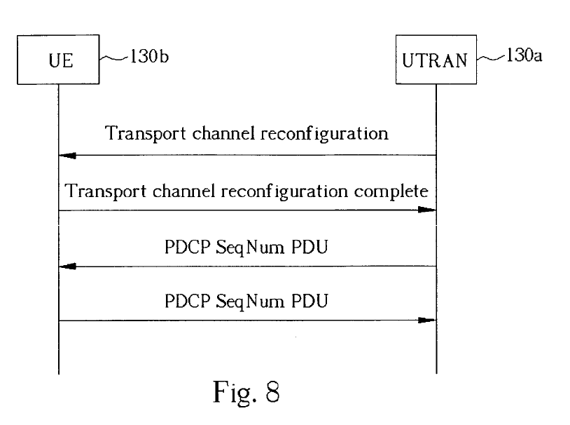

Please refer to FIG. 8 with reference to FIG. 5. FIG. 8 is a message sequence chart for performing a RRC 101 Transport Channel Reconfiguration procedure according to the present invention. A UTRAN 130a sends a standard Transport Channel Reconfiguration message to a UE 130b. This RRC 101 procedure reconfigures parameters related to a transport channel such as the TFS. The procedure also assigns a TFCS and may change physical channel parameters to reflect a reconfiguration of a transport channel in use. In response to the Transport Channel Reconfiguration procedure, the re-synchronization module 101r on the UTRAN 130a causes the RRC layer 101 to instruct the PDCP layer 102 to initiate a standard PDCP sequence number synchronization procedure for PDCP 102 peer entities belonging to radio bearers configured to support lossless SRNS Relocation. The re-synchronization module 101r on the UE 130b similarly causes a PDCP sequence number synchronization procedure to be performed.

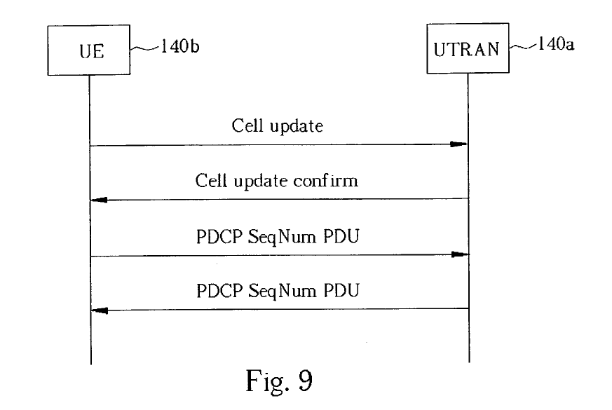

Please refer to FIG. 9 with reference to FIG. 5. FIG. 9 is a message sequence chart for performing a RRC 101 Cell Update procedure according to the present invention. A UE 140b sends a standard Cell Update message to a UTRAN 140a. The Cell Update procedure is performed when the UE 140b moves into another cell region, and is used to update the location of the UE 140b. In addition, amongst other things, the RRC 101 Cell Update procedure is also used to notify the UTRAN 140a of an unrecoverable error in an AM RLC 103 entity, to update the UTRAN 140a of the current cell the UE 140b is camping on after cell reselection, and to act upon a radio link failure. Furthermore, the Cell Update procedure may be combined with a re-establishment procedure for an AM RLC 103 entity, and RRC 101 Radio Bearer Release, Radio Bearer Reconfiguration, Transport Channel Reconfiguration or Physical Channel Reconfiguration procedures. In response to the Cell Update procedure, the re-synchronization module 101r on the UE 140b causes the RRC layer 101 to instruct the PDCP layer 102 to initiate a standard PDCP sequence number synchronization procedure for PDCP 102 peer entities belonging to radio bearers configured to support lossless SRNS Relocation. The re-synchronization module 101r on the UTRAN 140a similarly causes a PDCP sequence number synchronization procedure to be performed. It should be noted that when the Cell Update procedure is combined with a Radio Bearer Release, Radio Bearer Reconfiguration, or Transport Channel Reconfiguration procedure, the re-synchronization module 101r should cause only one PDCP sequence number synchronization procedure to take place. That is, the PDCP sequence number synchronization procedure that would normally occur under a Radio Bearer Release, Radio Bearer Reconfiguration or Transport Channel Reconfiguration procedure is abandoned in favor of the PDCP sequence number synchronization procedure that occurs after the Cell Update procedure.

In contrast to the prior art, the present invention provides a re-synchronization module in the RRC layer that performs a PDCP sequence number synchronization process in response to any RRC procedure that can lead to the loss of PDCP PDUs. These procedures include Transport Channel Reconfiguration, Radio Bearer Setup, Radio Bearer Release, and Cell Update procedures. Lossless transport of PDCP PDUs along the U-plane is therefore better ensured.

Those skilled in the art will readily observe that numerous modifications and alterations of the invention may be made while retaining the teachings of the invention. Accordingly, the above disclosure should be construed as limited only by the metes and bounds of the appended claims.

What is claimed is:

1. A method for determining triggering of a packet data convergence protocol (PDCP) number synchronization procedure in a wireless device, the wireless device utilizing a multi-layered protocol that includes:
a radio resource control (RRC) layer for establishing and configuring radio links according to a plurality of RRC procedures;
a PDCP layer for transfer of user data between PDCP peer entities to generate corresponding PDCP protocol data units (PDUs); and
a radio link control (RLC) layer for segmenting and concatenating the PDCP PDUs for a medium access control (MAC) layer;
the method comprising:
identifying execution of an RRC procedure selected from a set consisting of Transport Channel Reconfiguration, Radio Bearer Setup, Radio Bearer Release, and Cell Update procedures; and
in response to execution of the RRC procedure, triggering a PDCP number synchronization procedure.

2. The method of claim 1 wherein the PDCP number synchronization procedure is triggered only for a radio bearer configured to support lossless serving radio network system (SRNS) relocation.

3. The method of claim 2 wherein the RRC procedure is not combined with a SRNS Relocation procedure.

4. The method of claim 2 wherein the radio bearer is established prior to execution of the RRC procedure.

5. The method of claim 2 wherein the radio bearer is not released in response to the RRC procedure.

6. An improved wireless device comprising a packet data convergence protocol (PDCP) re-synchronization module for performing the following steps:
identifying execution of a Radio Resource Control (RRC) procedure selected from a set consisting of Transport Channel Reconfiguration, Radio Bearer Setup, Radio Bearer Release, and Cell Update procedures; and
in response to execution of the RRC procedure, triggering a PDCP number synchronization procedure.

7. The wireless device of claim 6 wherein the PDCP re-synchronization module triggers the PDCP number synchronization procedure only for a radio bearer configured to support lossless serving radio network system (SRNS) relocation.

8. The wireless device of claim 7 wherein the RRC procedure is not combined with a SRNS Relocation procedure.

9. The wireless device of claim 7 wherein the PDCP re-synchronization module triggers the PDCP number synchronization procedure only if the radio bearer is established prior to execution of the RRC procedure.

10. The wireless device of claim 7 wherein the PDCP re-synchronization module triggers the PDCP number synchronization procedure only if the radio bearer is not released in response to the RRC procedure.
